(19) United States
(12) Patent Application Publication
(10) Pub. No.: US 2011/0242287 A1
(43) Pub. Date: Oct. 6, 2011

(54) Stereoscopic Objective

(76) Inventors: Michael Cieslinski, Ottobrunn (DE); Hermann Popp, Munich (DE)

(21) Appl. No.: 13/072,845

(22) Filed: Mar. 28, 2011

(30) Foreign Application Priority Data
Mar. 31, 2010 (DE) DE102010013528.3

(51) Int. Cl. H04N 13/02; G02B 27/22; G03B 35/02; G02B 27/26

(52) U.S. Cl. 348/49; 359/462; 396/323; 352/63; 348/E13.074

(57) ABSTRACT

A stereoscopic objective for a camera includes a first receiving optics which directs a first beam path along a first optical axis, further a second receiving optics which directs a second beam path along a second optical axis, wherein the first optical axis and the second optical axis extend in parallel to one another or intersect one another. The object moreover includes a combination section which combines the first beam path and the second beam path and an output optics which directs the combined first and second beam paths along a common optical axis, wherein the first bream path and the second beam path spatially coincide within the second beam path.

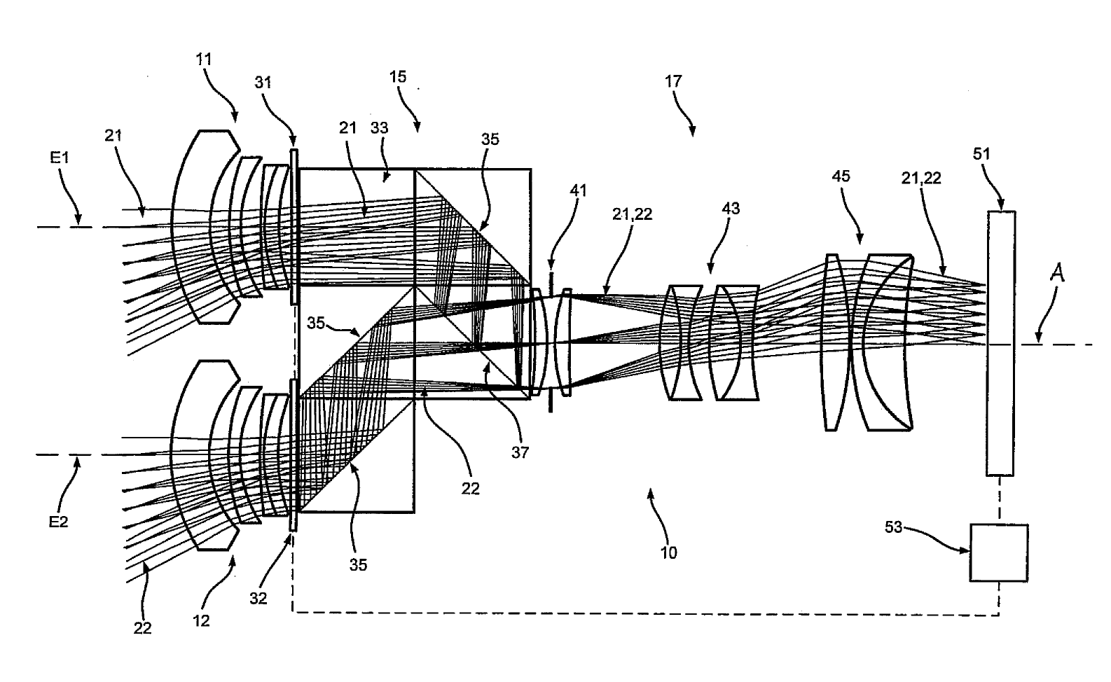

The invention relates to a stereoscopic objective for a camera, in particular for an electronic moving image camera or for a conventional motion picture camera.

Motion pictures are being produced to an increasing degree for a three-dimensional (3D) projection. It is necessary for this purpose to take two continuous image sequences from two different positions horizontally offset from one another. In this respect, the distance between pupils of the two taking positions typically approximately corresponds to the distance between the eyes in humans (approximately 65 mm).

The taking of the two image sequences usually takes place by two cameras which are synchronized with one another and have their own respective optics and their own respective image sensor or respective film carrier and film transport device. The two cameras are mounted on a common holder. Since the cameras and the objectives are, however, typically substantially wider than a desired distance between pupils, namely 160 mm, for example, mirrors additionally have to be interposed into the respective beam path.

The taking of 3D films using two substantially separate cameras is undesirably complex and/or expensive. The 3D taking device formed by the two cameras is bulky and heavy. It is furthermore difficult to find two objectives which are exactly the same so that it is ensured that the two image sequences taken in parallel have identical image properties. Two objectives which are as similar as possible are therefore usually selected from a plurality of objectives of the same construction.

It is an object of the invention to simplify the taking of 3D films, wherein the two image sequences taken in parallel should have image properties which are as identical as possible.

This object is satisfied by a stereoscopic objective in accordance with claim 1 having a first receiving optics which directs a first beam path along a first optical axis, furthermore having a second receiving optics which directs a second beam path along a second optical axis, wherein the first optical axis and the second optical axis extend parallel to one another or intersect one another, furthermore having a combining section which combines the first beam path and the second beam path, and having an output optics which directs the combined first and second beam paths along a common optical axis, wherein the first beam path and the second beam path coincide spatially within the output optics.

The stereoscopic objective has a first receiving optics and a second receiving optics to direct a first beam path and a second beam path along a respective optical axis. The two optical axes are offset from one another at the desired spacing (for example approximately 65 mm) and extend parallel to one another or intersect one another at a specific distance from the objective.

The stereoscopic objective furthermore has a combination section combines the first beam path and the second beam path. In other words, the combination section is coupled at its light inlet side to the first receiving optics and to the second receiving optics, wherein the two beam paths are merged in the combination section and are directed on together at a light outlet side of the combination section.

The light outlet side of the combination section is coupled to an output optics which directs the combined first and second beam paths along a common optical axis, in particular to an image sensor of an electronic moving image camera or to the film carrier of a conventional motion picture camera. The first bream path and the second beam path coincide spatially within the output optics, i.e. the first beam path and the second beam path take up the same cross-section within the output optics.

The stereoscopic objective thus has the two required receiving optics to realize the spacing between pupils for the taking of 3D films. The two beam paths hereby defined are, however, combined with one another in a combination section so that a common output optics can be used. The first beam path and the second beam path coincide spatially within the output optics so that the output optics is identically effective for both beam paths. It therefore only has to be ensured that the two receiving optics have identical optical properties. The two receiving optics can, however, be comparatively simple lenses or lens groups, in particular having a fixed focal length and aperture, i.e. without moving elements. The optical properties of the output optics in contrast anyway influence the two beam paths in an identical manner.

Only one single camera having a special objective is required instead of two separate cameras and objectives by the use of such a stereoscopic objective having a common output optics.

The output optics preferably includes at least one optical element having a variable optical property, wherein this optical element is also effective for the first beam path and the second beam path together. It is hereby ensured that the optical element with its variable optical property is also effective in an identical manner for both beam paths without differences arising in the two image sequences taken in parallel. For example, the named optical element can include an iris diaphragm (having a variable aperture i.e. with a variable free opening), a focusing device and/or a focal length setting device (zoom). A focusing device effective identically on both beam paths in particular bypasses the problem that an objective also frequently carries out a slight sideways movement on focusing, which would prove to be very disturbing with two different focusing devices for the two beam paths.

It is furthermore preferred if a first shutter is associated with the first beam path in order selectively to block or receive the first beam path and, if a second shutter is associated with the second beam path, in order selectively to block or release the second beam path, wherein a control device is provided to actuate the first shutter and the second shutter alternately. The first beam path and the second beam path can be blocked alternately by the two alternately actuated shutters. The images of the two image sequences taken in parallel are therefore hereby projected onto the image sensor or onto the film of the connected camera in time division multiplex. The camera can thus alternately take an image of the first beam path and an image of the second beam path without the fact proving to be disturbing that the two beam paths coincide spatially after their merging within the output optics.

The alternate taking of a respective image of the one image sequence and of the other image sequence also simplifies the later playback. On the projection of 3D films, the respective image information for the right eye and for the left eye are namely often shown after one another in time. For this purpose, in the case of images of the two image sequences taken simultaneously, an undesirably complex conversion of the image information is required (while taking account of the respective image taken beforehand or afterward). This conversion effort can be omitted if the images of the two image sequences are anyway taken offset from one another in time.

The first shutter is preferably arranged between the first receiving optics and the combination section of the stereoscopic objective and, in a corresponding manner, the second shutter is arranged between the second receiving optics and the combination section. A particularly simple arrangement of the two shutters hereby results. It is, however, also possible to arrange the two shutters within the respective receiving optics or within the combination section.

The two shutters can be formed by a common mechanical shutter which alternately blocks or releases the first and second beam paths.

The first shutter and the second shutter preferably, however, include a respective liquid crystal shutter (a so-called LCD shutter). It has two linear polarization filters which are rotated by 90° with respect to one another and between which the polarization direction of the incident light is selectively maintained (to block the respective beam path) or is rotated by 90° (to release the respective beam path). Such a liquid crystal shutter can be electronically controlled very simply and fast.

Provided that the linear polarization filters (for the different beam paths) provided at the respective inlet side of the two liquid crystal shutters are not effective in the same direction, it is preferred if a respective circular polarization filter or a depolarization device is provided before the respective liquid crystal shutter. This is in particular of advantage when the light incident into the stereoscopic objective does not have a random distribution of the polarization direction, but is rather more or less linearly polarized, such as is the case, for example, with light which is incident obliquely onto a surface of water and is reflected by it. It is ensured in such a case that different light quantities are not filtered out due to the linear polarization filters active in different directions, whereby the two image sequences taken in parallel would appear with different brightnesses.

As regards the named combination section of the stereoscopic objective, it can have a beam splitter which is effective independent of polarization (e.g. a mirror or beam splitting coating of a prism beam splitter cube). A first linear polarization filter is preferably provided before the beam splitter and polarizes the first beam path linearly in a first direction, wherein a second linear polarization filter is also provided in front of the beam splitter and polarizes the second beam path linearly in a second direction which is rotated by 90° to the named first direction. The beam splitter effective independently of polarization reflects the light polarized in the one direction, whereas it is permeable for the light polarized in the second direction. Losses and mutual optical interference of the two beam paths in the combination section are hereby effectively avoided. The two linear polarization filters can in particular be formed by those linear polarization filters which are anyway provided in the aforesaid liquid crystal shutters.

It is also preferred in this embodiment if a respective circular polarization filter or a respective depolarization device is provided in front of the beam splitter for the first beam path and the second beam path. Since linear polarization filters which are effective in different directions are interposed before the beam splitter, it is thus avoided that different light quantities are output for the first beam path and for the second beam path if the incident light does not have any random distribution of the polarization, but is rather more or less linearly polarized, as explained above.

It is further of advantage if a first beam cross-section restricting device which restricts the cross-section of the first beam path is provided in front of the beam splitter and if a second beam cross-section restricting device which restricts the cross-section of the second beam path is also provided in front of the beam splitter. These beam cross-section restricting devices can be arranged in the receiving optics or in the combination section of the stereoscopic objective. The respective beam cross-section restricting device can be formed, for example, by a diaphragm having a fixed aperture or by a fixed part of the receiving optics. The respective bream cross-section restricting device constricts the respective beam and thus contributes to limiting the dimensions of the beam splitter.

It is furthermore preferred if the first beam path and the second beam path cover the same optical path length within the combination section. This also contributes to the output optics being effective in the same manner on the two beam paths.

In accordance with a particularly advantageous embodiment, the combination section of the stereoscopic objective combines the first beam path and the second beam path such that both the first beam path and the second beam path extend over the full aperture within the output optics, that is over the total available free opening of the output optics. It is hereby in particular avoided that a point located in the object space outside the position of focus in the image plane (i.e. in the plane of the image sensor or of the film) appears not as a circle, but only as a semicircle. The latter can, for example, be the case when the first beam path is only directed along one half of the output optics and the second beam path is only directed along the other half of the output optics.

It is preferred for this purpose if the combination section of the stereoscopic objective has a beam splitter which—viewed along the optical axis of the output optics—extends over the full aperture of the output optics.

For example, the combination section of the stereoscopic objective for the first bream path and for the second beam path can have a prism beam splitter cube having a beam splitter coating which is aligned at an angle of approximately 45° with respect to the optical axis of the output optics and which—viewed along the optical axis of the output optics—extends over the full aperture of the output optics. It is preferred in this embodiment that the combination section for the first beam path has a fiber optic cube disposed after the first receiving optics and a deflection prism having a mirror coating which is aligned with respect to the first optical axis of the stereoscopic objective at an angle of approximately 45° and substantially parallel to the beam splitter coating of the prism beam splitter cube. The combination section can then have a first deflection prism for the second beam path which is disposed after the second receiving optics and which has a mirror coating which is aligned at an angle of approximately 45° with respect to the second optical axis of the stereoscopic objective and a second deflection prism having a mirror coating which is aligned substantially parallel to the mirror coating of the first deflection prism and at an angle of approximately 90° with respect to the beam splitter coating of the prism beam splitter cube. The required offset of the first optical axis and of the second optical axis relative to one another and relative to the optical axis of the output optics is effected by the named deflection prisms having a respective mirror coating. Alternatively to the use of prisms, however, simple mirrors can also be used.

The invention also relates to an electronic moving image camera having an optoelectronic image sensor and a stereoscopic objective which includes a respective shutter for the first beam path and for the second beam path as well as an associated control device (as explained above). The control device is designed to synchronize the alternate actuation of the tow shutters with the reading out of the image sensor such that the image sensor alternatively takes an image corresponding to the first beam path and an image corresponding to the second beam path. In other words, the control device provides that the image sensor takes an image of the first image sequence when the first shutter releases the first beam path and the second shutter blocks the second beam path and that the image sensor takes an image of the second image sequence when the first shutter blocks the first beam path and the second shutter releases the second beam path.

The invention furthermore also relates to a motion picture camera having a film transport device for the intermittent transport of a film along a film advance direction and having a stereoscopic objective of the explained kind which includes a respective shutter for the first beam path and for the second beam path as well as an associated control device. With such a motion picture camera, a section of the film located in the image plane of the objective is generally exposed. The control device is now designed to synchronize the alternate actuation of the first shutter and of the second shutter with the intermitting transport of the film such that the film is exposed alternately along the film advance direction with an image corresponding to the first beam path and an image corresponding to the second beam path. The control device thus provides that the film is exposed with an image of the first image sequence when the first shutter releases the first beam path and the second shutter blocks the second beam path and that the film is exposed with an image of the second image sequence when the first shutter blocks the first beam path and the second shutter releases the second beam path.

The invention will be described in the following only by way of example with reference to the drawing. The only FIGURE shows a schematic longitudinal cross-section of a stereoscopic objective 10.

The stereoscopic objective 10 includes a first receiving optics 11, a second receiving optics 12, a combination section 15 and an output optics 17.

The first receiving optics 11 directs a first beam path 21 along a first optical axis E1 and the second receiving optics 12 directs a second beam pat 22 along a second optical axis E2. The first optical axis E1 and the second optical axis E2 substantially extend offset in parallel to one another. The spacing between the two optical exes E1 and E2 amounts to approximately 65 mm at the location of the receiving optics 11, 12.

A first shutter 31 is provided between the first receiving optics 11 and the combination section 15 and a second shutter 32 is provided between the second receiving optics 12 and the combination section 15. Each shutter 31, 32 is designed as a liquid crystal shutter which has two linear polarization filters rotated by 90° with respect to one another and which selectively leaves the polarization direction of the incident light unchanged or rotates it by 90° between the two linear polarization filters. The linear polarization filters at the respective outlet side of the two shutters 31, 32 are rotated by 90° with respect to one another.

The combination section 15 of the stereoscopic objective 10 includes a plurality of mirrors which are formed by a respective deflection prism 35 to direct the first beam path 21 and the second beam path 22 to a beam splitter 37, as will be explained in the following. The beam splitter 37 is designed as a prism beam splitter cube having a dielectric polarizing splitter coating. The beam splitter 37 is thus transparent for the light of the one polarization direction, whereas it reflects the light of the other polarization direction. The first shutter 31 provided for the first beam path 21 can, for example, at its outlet side be permeable for light which is polarized perpendicular to the shown sectional plane and the beam splitter 37 is reflective for this polarization direction. The second shutter 32 provided for the second beam path 22, in contrast, is in this case at its outlet side permeable for light which is polarized within the shown sectional plane, with the beam splitter 37 being permeable for this polarization direction.

The splitter coating of the beam splitter 17 is aligned at an angle of approximately 45° with respect to the optical axis A of the output optics 17 and it extends—viewed along the optical axis A—over the full aperture of the output optics 17. For the first beam path 21, the combination section 15 includes a fiber optic cube 33 (for adaptation of the optical path length) disposed after the first receiving optics 11 and a deflection prism 35 having a mirror coating which is aligned at an angle of approximately 45° with respect to the first optical axis E1 and substantially parallel to the splitter coating of the prism beam splitter cube 37. For the second beam path 22, the combination section 15 includes a first deflection prism 35 disposed after the second receiving optics 12 and having a mirror coating which is aligned at an angle of approximately 45° with respect to the second optical axis E2 and a second deflection prism 354 having a mirror coating which is aligned substantially in parallel to the mirror coating of the first deflection prism 35 and at an angle of approximately 90° with respect to the splitter coating of the prism beam splitter cube 37.

The output optics 17 includes a plurality of lens groups which have a common optical axis A. The output optics 17 includes an iris diaphragm 41. One of the named lens groups forms a focusing device 43, wherein one or more lenses is or are movable along the optical axis A. Furthermore, one of the named lens groups of the output optics 17 forms a focal length adjustment device 45, wherein one or more lenses is or are also movable along the optical axis A here. The adjustment devices present in connection with the output optics 17 are of conventional construction and are not shown in any more detail.

The stereoscopic objective 10 shown is associated, for example, with an electronic moving image camera which includes an optoelectronic image sensor 51 and an electronic control device 53.

The stereoscopic objective 10 allows two image sequences which correspond to the first beam path 21 and to the second beam path 22 to be taken in parallel using a single camera. This is down by a time division multiplex, i.e. the light acting on the stereoscopic objective 10 is alternately directed to the image sensor 51 at the outer side of the objective 10 in accordance with the first bream path 31 or in accordance with the second beam path 22.

For this purpose, the control device 53 alternately actuates the two shutters 31, 32 and synchronously hereto effects a respective taking of an image by the image sensor 51. In other words, at a given point in time, the first shutter 31 is opened to take an image on the image sensor 51 by means of the first receiving optics 11 and by means of the output optics 17, whereas the second beam path 22 is interrupted by means of the second shutter 32. The image sensor 51 in this respect takes an image of a first image sequence. At a later point in time, the first shutter 31 is closed, whereas the second shutter 32 is open so that now the second beam path 22 is released and the image sensor 51 can take an image of a second image sequence.

It must be noted that the beam paths 21, 22 shown only illustrate the optical imaging relationships. It can in particular be seen that the first bream path 21 and the second beam path 22 are optically merged within the combination section 15 by means of the beam splitter 37, i.e. the first beam path 21 and the second beam path 22 completely coincide spatially at the outlet side of the combination section 15 and within the output optics 17 and take up the total available cross-section area (aperture of the output optics 17). During time division multiplex operation, it is, however, the case, that always only one of the two beam paths 21, 22 is released by the alternate actuation of the two shutters 31, 32 within the combination section 15 and the output optics 17.

It is understood that the image sensor 51 has to be operated at a double image frame rate to take the same number of images overall as on the use of two separate cameras running synchronously with one another.

Instead of for an electronic moving image camera with an image sensor, the stereoscopic objective 1 can also be used in a conventional motion picture camera to image the object space alternately by time division multiplex along the first beam path 21 and along the second beam path 22 onto the intermittently transported film. For this purpose, the alternate actuation of the first shutter 31 and of the second shutter 32 is synchronized with the intermittent transport of the film within the motion picture camera.

A substantial cost reduction results with respect to a conventional arrangement having two separate moving image cameras since only one single camera is required. The arrangement is hereby also much smaller and lighter, which is in particular of significant importance for reports, documentaries and news broadcasts. Optical elements having variable optical properties can above all be used to influence the image taking without any different image properties appearing for the two image sequences during the taking. The aperture of the iris diaphragm 41 can in particular be changed during the ongoing taking or the focusing device 43 can be actuated, wherein the changes hereby caused in the image properties become noticeable in an identical manner for both image sequences. It is even possible to actuate the focal length adjustment device 45 during the ongoing taking, which is problematic with conventional 3D camera arrangements due to the lack of an even speed of two separate zoom objectives. The fact is also utilized here that the output optics 17 is identically effective for the two beam paths 21, 22.

### REFERENCE NUMERAL LIST

10 stereoscopic objective
11 first receiving optics
12 second receiving optics
15 combination section
17 output optics
21 first beam path
22 second beam path
31 first shutter
32 second shutter
33 fiber optic cube
35 deflection prism
37 beam splitter
41 iris diaphragm
43 focusing device
45 focal length adjustment device
51 image sensor
53 control device
E1 optical axis of the first receiving optics
E2 optical axis of the second receiving optics
A optical axis of the output optics

1. A stereoscopic objective (10) for a camera,
having a first receiving optics (11) which directs a first beam path (21) along a first optical axis (E1);
further having a second receiving optics (12) which directs a second beam path (22) along a second optical axis (E2),
wherein the first optical axis and the second optical axis extend parallel to one another or intersect one another;
further having a combination section (15) which combines the first beam path (21) and the second beam path (22); and
having an output optics (17) which directs the combined first and second beam paths (21, 22) along a common optical axis (A), with the first beam path (21) and the second beam path (22) spatially coinciding within the output optics (17).

2. A stereoscopic objective in accordance with claim 1, wherein the output optics (17) has at least one optical element having a variable optical property, wherein the optical element is effective for the first beam path (21) and for the second beam path (22 together).

3. A stereoscopic objective in accordance with claim 2, wherein the optical element in particular includes an iris diaphragm (41) having a variable aperture, a focusing device (43) and/or a focal length adjustment device (45).

4. A stereoscopic objective in accordance with claim 1, wherein a first shutter (31) is associated with the first beam path (21) in order selectively to block or release the first beam path, wherein a second shutter (32 is associated with the second beam path (22) in order selectively to block or release the second beam path, and wherein a control device (53) is provided to actuate the first shutter and the second shutter alternately.

5. A stereoscopic objective in accordance with claim 4, wherein the first shutter (31) is arranged between the first receiving optics (11) and the combination section (15), and wherein the second shutter is arranged between the second receiving optics (12) and the combination section (15).

6. A stereoscopic objective in accordance with claim 4, wherein the first shutter (31) and the second shutter (32) have a respective liquid crystal shutter which has two linear polarization filters rotated by 90° with respect to one another and which selectively maintains the polarization direction of the light between the two filters or rotates it by 90°.

7. A stereoscopic objective in accordance with claim 6, wherein a respective circular polarization filter or a respective depolarization device is provided in front of the respective liquid crystal shutter.

8. A stereoscopic objective in accordance with claim 1, wherein the combination section (15) has a beam splitter (37) effective in dependence on polarization, wherein a first linear polarization filter is provided in front of the beam splitter which linearly polarizes the first beam path (21) in a first direction, wherein a second linear polarization filter is provide in front of the beam splitter which linearly polarizes the second beam path (22) in a second direction rotated by 90° with respect to the first direction, and wherein the beam splitter (37) reflects light polarized in the first direction and is permeable for light polarized in the second direction.

9. A stereoscopic objective in accordance with claim 8, wherein the beam splitter (37) extends, viewed along the optical axis (A) of the output optics (17), over the full aperture of the output optics (17).

10. A stereoscopic objective in accordance with claim 8, wherein a respective circular polarization filter or a respective depolarization device is provided in front of the beam splitter (37) for the first beam path (21) and for the second beam path (22).

11. A stereoscopic objective in accordance with claim 10, wherein the beam splitter (37) extends, viewed along the optical axis (A) of the output optics (17), over the full aperture of the output optics (17).

12. A stereoscopic objective in accordance with claim 8, wherein a first beam cross-section restricting device is provided in front of the beam splitter (37) which restricts the cross-section of the first beam path (21), and wherein a second beam cross-section restricting device is provided in front of the beam splitter (37) which restricts the cross-section of the second beam path (22).

13. A stereoscopic objective in accordance with claim 1, wherein the combination section (15) combines the first beam path (21) and the second beam path (22) such that both the first beam path (21) and the second beam path (22) extend over the full aperture of the output optics (17) within the output optics (17).

14. A stereoscopic objective in accordance with claim 1, wherein the combination section (15) has a beam splitter (37) which extends, viewed along the optical axis (A) of the output optics (17), over the full aperture of the output optics (17).

15. A stereoscopic objective in accordance with claim 1, wherein the combination section (15) for the first beam path (1) and for the second beam path (22) has a prism beam splitter cube (37) having a beam splitter coating which is aligned at an angle of 45° with respect to the optical axis (A) of the output optics (17) and which extends, viewed along the optical axis (A) of the output optics (17), over the full aperture of the output optics (17).

16. A stereoscopic objective in accordance with claim 15, wherein the beam splitter coating forms a beam splitter effective in dependence on polarization, wherein a first linear polarization filter is provided in front of the beam splitter which linearly polarizes the first beam path (21) in a first direction, wherein a second linear polarization filter is provide in front of the second beam splitter which linearly polarizes the second beam path (22) in a second direction rotated by 90° with respect to the first direction, and wherein the beam splitter (37) reflects light polarized in the first direction and is permeable for light polarized in the second direction.

17. A stereoscopic objective in accordance with claim 15, wherein the combination section (15) for the first beam path (21) has a fiber optic cube (33) arranged after the first receiving optics (11) and a deflection prism (35) having a mirror coating which is aligned at an angle of 45° with respect to the first optical axis (E1) and parallel to the beam splitter coating of the prism beam splitter cube (37), and wherein the combination section (15) for the second beam path (22) has a first deflection prism (35) arranged after the second receiving optics (12) and having a mirror coating which is aligned at an angle of 45° with respect to the second optical axis (E2), and has a second deflection prism (35) having a mirror coating which is aligned parallel to the mirror coating of the first deflection prism (35) and at an angle of 90° with respect to the beam splitter coating of the prism beam splitter cube (37).

18. A electronic moving image camera having a stereoscopic objective (10), an image sensor (51) and a control device (53), wherein the stereoscopic objective (10) includes:
a first receiving optics (11) which directs a first beam path (21) along a first optical axis (E1);
a second receiving optics (12) which directs a second beam path (22) along a second optical axis (E2), wherein the first optical axis and the second optical axis extend parallel to one another or intersect one another;
a combination section (15) which combines the first beam path (21) and the second beam path (22); and
an output optics (17) which directs the combined first and second beam paths (21, 22) along a common optical axis (A), with the first beam path (21) and the second beam path (22) spatially coinciding within the output optics (17),
wherein a first shutter (31) is associated with the first beam path (21) in order selectively to block or release the first beam path, wherein a second shutter (32) is associated with the second beam path (22) in order selectively to block or release the second beam path, wherein the control device (53 actuates the first shutter and the second shutter alternately, and wherein the control device (53) is designed to synchronize the alternate actuation of the first shutter (31) and of the second shutter (32) with the reading out of the image sensor such that the image sensor (51) alternately takes an image corresponding to the first beam path (21) and an image corresponding to the second beam path (22).

19. An electronic moving image camera in accordance with claim 18, wherein the combination section (15) has a beam splitter (37) effective in dependence on polarization, wherein a first linear polarization filter is provided in front of the beam splitter which linearly polarizes the first beam path (21) in a first direction, wherein a second linear polarization filter is provide in front of the beam splitter which linearly polarizes the second beam path (2) in a second direction rotated by 90D with respect to the first direction, and wherein the beam splitter (37) reflects light polarized in the first direction and is permeable for light polarized in the second direction.

20. A motion picture camera having a stereoscopic objective (10), a film transport device for the intermittent transport of a film along a film advance direction and a control device (53), wherein the stereoscopic objective (10) includes:
a first receiving optics (11) which directs a first beam path (21) along a first optical axis (E1);
a second receiving optics (12) which directs a second beam path (22) along a second optical axis (E2), wherein the first optical axis and the second optical axis extend parallel to one another or intersect one another;
a combination section (15) which combines the first beam path (21) and the second beam path (22); and
an output optics (17) which directs the combined first and second beam paths (21, 22) along a common optical axis (A), with the first beam path (21) and the second beam path (22) spatially coinciding within the output optics (17),
wherein a first shutter (31) is associated with the first beam path (21) in order selectively to block or release the first beam path, wherein a second shutter (32) is associated with the second beam path (22) in order selectively to block or release the second beam path, wherein the control device (53) actuates the first shutter and the second shutter alternately, and wherein the control device (53) is designed to synchronize the alternate actuation of the first shutter (31) and of the second shutter (32) with the intermittent transport of the film such that the film is alternately exposed along the film advance direction with an image corresponding to the first beam path (231) and with an image corresponding to the second beam path (22).

21. A motion picture camera in accordance with claim 20, wherein the combination section (15) has a beam splitter (37) effective in dependence on polarization, wherein a first linear polarization filter is provided in front of the beam splitter which linearly polarizes the first beam path (21) in a first direction, wherein a second linear polarization filter is provide in front of the beam splitter which linearly polarizes the second beam path (22) in a second direction rotated by 90° with respect to the first direction, and wherein the beam splitter (37) reflects light polarized in the first direction and is permeable for light polarized in the second direction.
